(19) United States
(12) Patent Application Publication
(10) Pub. No.: US 2015/0241636 A1
(43) Pub. Date: Aug. 27, 2015

(54) OPTICAL MODULE AND LIGHT TRANSMISSION METHOD

(71) Applicant: Mitsubishi Electric Corporation, Chiyoda-ku (JP)

(72) Inventors: Nobuo OHATA, Chiyoda-ku (JP); Fumio SHOHDA, Chiyoda-ku (JP)

(73) Assignee: Mitsubishi Electric Corporation, Chiyoda-ku (JP)

(21) Appl. No.: 14/459,491

(22) Filed: Aug. 14, 2014

(30) Foreign Application Priority Data
Feb. 27, 2014 (JP) 2014-037178

(51) Int. Cl. G02B 6/32

(52) U.S. Cl. CPC G02B 6/325

(57) ABSTRACT

To provide an optical module and a light transmission method for controlling position shifts of a focal point easily and flexibly. An optical module comprises a lens, a lens cap and a transparent member. The lens causes laser light emitted from a semiconductor laser to be focused at a focal point. The lens cap supports the lens. The transparent member is anchored to the lens cap such that an asymmetric force centered on the optical axis of the lens is applied in accordance with thermal expansion. The transparent member is disposed on the optical path.

### CROSS-REFERENCE TO RELATED APPLICATION

This application claims the benefit of Japanese Patent Application No. 2014-37178, filed on Feb. 27, 2014, the disclosures of which are incorporated by reference herein.

### FIELD

This application relates generally to an optical module and a light transmission method.

### BACKGROUND

Accompanying expansion of communication volumes on the Internet in recent years, optical modules have been sought that are capable of transmitting high-speed optical signals in optical access systems. The desired transmission speed for high-speed optical signals is, for example, around 10 Gbps.

In addition to high-speed signal transmission, low cost is also demanded in optical modules. Hence, in recent years an inexpensive package called a TO-CAN (Transistor Outlined CAN) type has been used more than the BOX-type package that was previously used. Below, this kind of package is called a TO-CAN type package.

In an optical module, the semiconductor laser and/or the like produces heat. In addition, the optical module receives the effects of environmental temperature changes. Property changes due to temperature fluctuations in the semiconductor laser caused by such factors should be prevented, so in an optical module, a Peltier device that keeps the temperature of peripheral components constant is positioned on the stem.

Because the temperature typically differs between temperature-controlled surfaces and the heat-exhaust surfaces in a Peltier device, a temperature distribution arises in the Peltier device itself. The position of the semiconductor laser at times fluctuates in the direction of the optical axis due to thermal expansion of the Peltier device in accordance with the temperature distribution. As a result, the distance between the semiconductor laser and the lens fluctuates, so the position of the focal point of light via the lens shifts in the optical axis direction. In addition, lens caps are often used in TO-CAN type packages, but because the thermal expansion of the cap is larger than the thermal expansion of the Peltier device, the distance between the semiconductor laser and the lens fluctuates and the position of the focal point of light shifts in the optical axis direction.

In addition, due to the difference between the temperature distribution of the stem and the linear thermal expansion coefficient of components mounted on the stem, the stem at times undergoes elastic deformation accompanying fluctuations in environmental temperature. The elastic deformation of the stem at times causes the position of the semiconductor laser to fluctuate in a direction orthogonal to the optical axis direction. As a result, the position of the focal point of light shifts in a direction orthogonal to the optical axis direction.

In this way, in the optical module the position of the focal point of light shifts in the optical axis direction and a direction orthogonal to the optical axis direction from the incident end of an optical fiber, due to temperature fluctuations, and the optical coupling efficiency into an optical fiber declines. When the optical coupling efficiency declines, tracking errors in which the light output from the optical fiber fluctuates occur.

In order to mitigate tracking errors, a TO-CAN type package has been disclosed in which a separate lens is disposed between the lens and the semiconductor laser exit on the Peltier device (for example, see Patent Literature 1). This TO-CAN type package mitigates tracking errors by making collimated light of the laser light emitted from the semiconductor laser exit by the lens positioned between the lens and the semiconductor laser exit.

In addition, a light transmission module has been disclosed in which a component having a prescribed refractive-index temperature-change property is placed between the lens and the optical fiber (for example, see Patent Literature 2). Between the focal point of laser light via the lens and the core center at the incident end of the optical fiber, a position shift occurs in a direction orthogonal to the optical axis of the lens due to the difference in thermal expansion coefficients between the semiconductor laser and lens. This light transmission module reduces the position shift using this component.

Patent Literature 1: Unexamined Japanese Patent Application Kokai Publication No. 2011-108937

### Patent Literature 2: Unexamined Japanese Patent Application Kokai Publication No. 2003-248144

### SUMMARY

With the TO-CAN type package disclosed in Patent Literature 1, additional lenses are necessary. In addition to costs rising due to the additional lenses, it is necessary to accurately position the lenses in order to create collimated light. This does not satisfy the need for lower costs and causes the package to become larger. In addition, with the light transmission module disclosed in Patent Literature 2, it is impossible to reduce tracking errors caused by position shifts related to the optical axis direction of the focal point of laser light via the lens.

In consideration of the foregoing, it is an objective of the present disclosure to provide an optical module and light transmission method for easily and flexibly controlling position shills of the focal point.

In order to achieve the above-described objective, the optical module according to the present disclosure comprises an optical device, a support body and a transparent member. The optical device causes light emitted from an exit point to be focused at a focal point. The support body supports the optical device. The transparent member is anchored to the support body such that an asymmetric force centered on the optical axis of the optical device is applied in accordance with thermal expansion. The transparent member is disposed on the optical path.

With the present disclosure, the transparent member deforms and the optical axis of the transparent member moves so as to control the position shifts of the focal point accompanying position shifts of the exit point relative to the optical device caused by temperature changes.

### BRIEF DESCRIPTION OF THE DRAWINGS

A more complete understanding of this application can be obtained when the following detailed description is considered in conjunction with the following drawings, in which:

FIG. 1 a drawing showing the composition of an optical module according to a first embodiment of the present disclosure;

FIG. 2 is a drawing showing the shape of a transparent member in the optical module shown in FIG. 1;

FIG. 3 is a drawing explaining the relationship between temperature changes in the optical module and position shifting by the focal point, with (A) showing the status of the optical module at a temperature of 25° C. and (B) showing the status of the optical module at a temperature of 75° C.;

FIG. 4 is a drawing showing the change in shape of the transparent member mounted in the optical module with respect of temperature changes in the optical module;

FIG. 5 is a drawing showing the positional relationships between the focal point and the exit point, and between the optical axes of the lens and the transparent member, in the optical module shown in FIG. 1;

FIG. 6 is a drawing showing the positional relationships among the exit point viewed from the direction of the optical axis of the lens, and the optical axes of the lens and transparent member, in the optical module shown in FIG. 1;

FIG. 7 is a drawing showing one example of the shape of the transparent member in the optical module;

FIG. 8 is a drawing showing the shape of the transparent member in an optical module according to a second embodiment of the present disclosure;

FIG. 9 is a drawing showing the composition of the optical module according to the second embodiment of the present disclosure;

FIG. 10 is a drawing showing the positional relationships between the focal point and the exit point, and between the optical axes of the lens and the transparent member, in the optical module shown in FIG. 9;

FIG. 11 is a drawing showing the positional relationships among the exit point viewed from the direction of the optical axis of the lens, and the optical axes of the lens and transparent member, in the optical module shown in FIG. 9;

FIG. 12 is a drawing showing the shape of a transparent member in an optical module according to a third embodiment of the present disclosure;

FIG. 13 is a drawing showing the mounting state of a transparent member in an optical module according to a fourth embodiment of the present disclosure;

FIG. 14 is a drawing showing the mounting state of a transparent member in an optical module according to a fifth embodiment of the present disclosure; and

FIG. 15 is a drawing showing the composition of an optical module according to a sixth embodiment of the present disclosure.

### DETAILED DESCRIPTION

The embodiments of the present disclosure are explained with reference to the attached drawings. However, the present disclosure is not limited by the below-described embodiments or drawings.

### First Embodiment

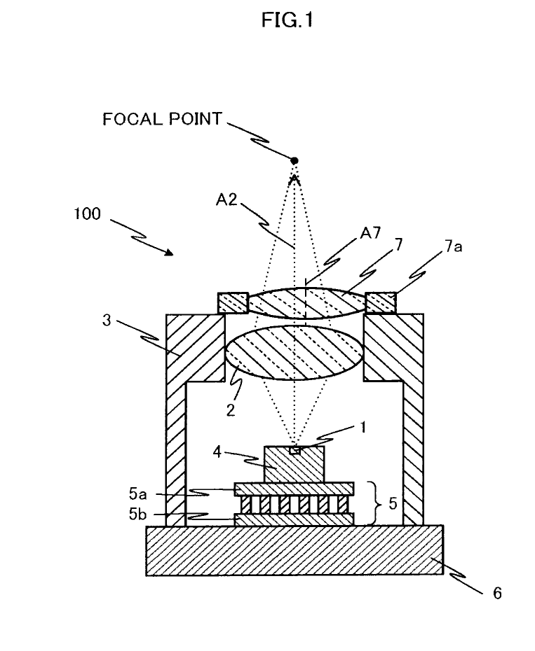

First, an optical module 100 according to a first embodiment of the present disclosure is described taking as an example a TO-CAN (Transistor Outlined CAN) type for use in optical communications, with reference to FIG. 1.

The optical module 100 comprises a semiconductor laser 1 that emits laser light, a biconvex lens (optical device) 2 on which the laser light is incident, a lens cap (support body) 3 for supporting the lens 2, a carrier 4 on which the semiconductor laser 1 is mounted, a Peltier device 5 on which the carrier 4 is carried, a stem 6 carrying the semiconductor laser 1 via the carrier 4 and the Peltier device 5, and a transparent member 7 anchored to the lens cap 3 and disposed on the optical path.

The semiconductor laser 1 emits laser light toward the lens 2. The position of the semiconductor laser 1 is the exit point of the laser light. Laser light emitted from the semiconductor laser 1 is incident on the lens 2.

The lens 2 focusses the laser light emitted from the semiconductor laser 1 to a focal point. The position corresponding to the focal point is for example disposed at the input end of an optical fiber connected to the optical module 100.

The lens cap 3 is cylindrical along the direction of the optical axis of the laser light emitted from the semiconductor laser 1. One end of the lens cap 3 is anchored to the stem 6. On the other edge, the lens cap 3 supports the lens 2 so that the semiconductor laser 1 is positioned inside. The lens cap 3 is formed of metal materials such as stainless steel (SUS) or SF20T and/or the like.

The carrier 4 supports the semiconductor laser 1. The properties of the semiconductor laser 1 change greatly due to temperature changes in the optical module 100 accompanying fluctuations in the environmental temperature of the optical module 100 and heat generation by the semiconductor laser 1. In order to keep changes in the properties of the semiconductor laser 1 caused by temperature changes within a fixed range, the carrier 4 is positioned in contact with the top surface of the Peltier device 5 as an electronic cooling device. The carrier 4 is for example made of metal such as a metallic compound of copper and tungsten, and/or the like.

The Peltier device 5 comprises a top layer 5a the surface of which is a temperature-regulating surface, and a bottom layer 5b, the surface of which is a heat-discharging surface. The top layer 5a is connected to a temperature sensor such as a thermistor and/or the like. The temperature of the top layer 5a is controlled to be a constant based on the temperature measured by the temperature sensor. As a result, the temperatures of the carrier 4 and the semiconductor laser 1 are maintained at a constant, so thermal expansion is curtailed in the members surrounding the semiconductor laser 1. The bottom layer 5b is in contact with the stem 6, so heat generated when the semiconductor laser 1 is in operation can be efficiently eliminated via the stem 6.

The above-described various components are mounted on the stem 6. The stem 6 is made of cold-rolled steel with a high thermal conductivity, and/or the like, in order to efficiently eliminate heat generated when the optical module 100 is in operation.

The lens cap 3 is attached to the stem 6 independent of the Peltier device 5, whose temperature is controlled. Consequently, the lens cap 3 thermally expands and contracts because of temperature changes in the optical module 100. When the lens cap 3 thermally expands, the position of the semiconductor laser 1 relative to the lens 2 that focusses laser light at the focal point fluctuates, so the focal point fluctuates before and after temperature changes.

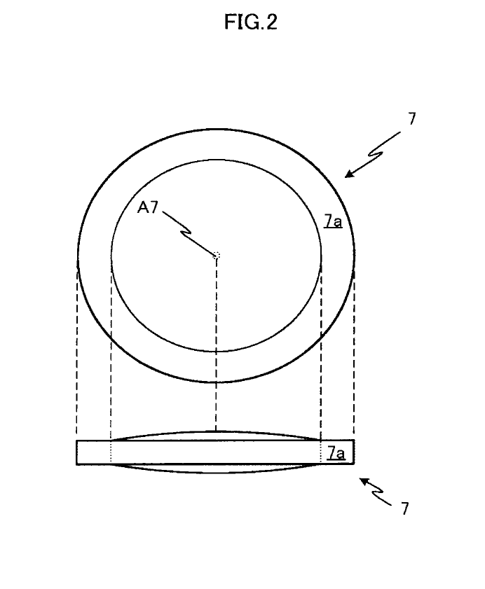

The transparent member 7 is made of plastic. Consequently, the refractivity of the transparent member 7 is larger than the refractivity of the atmosphere. As shown in FIG. 2, the transparent member 7 has a biconvex shape and is such that the surface on the semiconductor laser 1 side and the surface on the focal point side are curved surfaces having equal curvatures. The transparent member 7 passes the laser light (emitted light) emitted from the semiconductor laser 1 primarily via the curved surfaces. The shape of the transparent member 7 is rotationally symmetric about the optical axis A7 of the transparent member 7. Returning to FIG. 1, the optical axis A7 of the transparent member 7 is anchored to the lens cap 3 so as to be shifted from the optical axis A2 of the lens 2. Specifically, the transparent member 7 is anchored by an adhesive to the lens cap 3 via a rim 7a. When the lens cap 3 thermally expands accompanying an increase in temperature, the transparent member 7 is anchored to the lens cap 3, so uniform forces are applied to the transparent member 7, centered on the optical axis A2 of the lens 2. In contrast, the optical axis A7 of the transparent member 7 is shifted from the optical axis A2 of the lens 2, so an asymmetric force is applied to the transparent member 7 in accordance with thermal expansion, centered on the optical axis A2 of the lens 2. The transparent member 7 moves so that the optical axis A7 thereof controls position shifting of the focal point accompanying position shifting of the exit point to the lens 2 caused by temperature changes, due to deformation caused by the asymmetric force centered on the optical axis A2 of the lens 2.

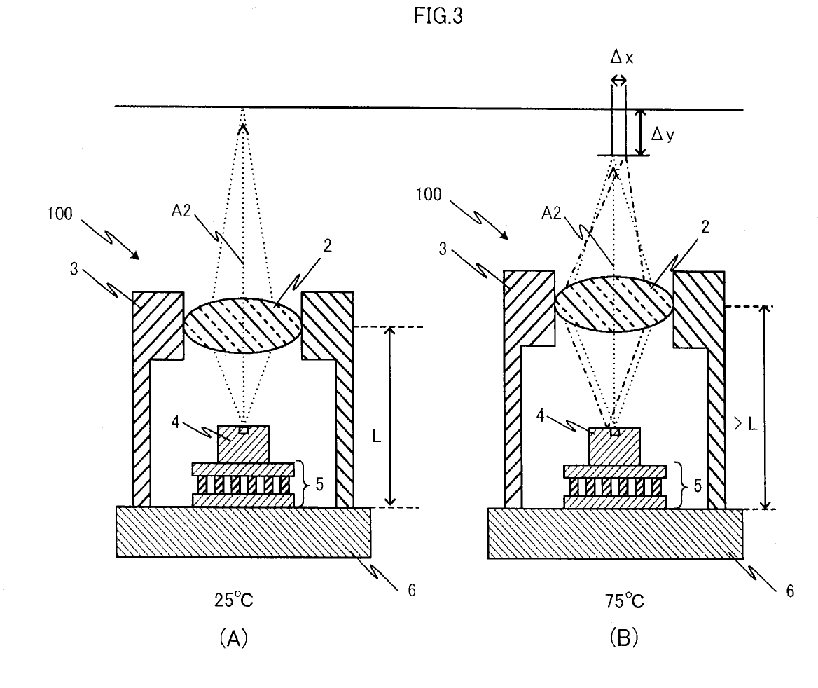

Here, temperature changes of the optical module 100 and position shifting of the focal point are explained for a case in which the transparent member 7 is not disposed. In FIG. 3, (A) shows a state in which the semiconductor laser 1 emits laser light. At this time, the temperature of the optical module 100 is room temperature and here is 25° C. In addition, the Peltier device 5 is assumed to be driven so as to adjust the semiconductor laser 1 to a desired temperature. When the temperature of the optical module 100 is 25° C., the length from the top surface of the stem 6 to the center of the lens 2 is L.

In FIG. 3, (B) shows the state when the environmental temperature is assumed to have changed so that the temperature of the optical module 100 becomes 75° C. in the states of (A) in FIG. 3. When the temperature of the optical module 100 becomes 75° C. the length from the top surface of the stem 6 to the center of the lens 2 becomes longer than L due to thermal expansion. At times the Peltier device 5 itself also thermally expands, and at times the position of the semiconductor laser 1 fluctuates in the direction of the lens 2. However, thermal expansion of the Peltier device 5 is small compared to thermal expansion of the lens cap 3, so the position shift of the lens 2 caused by thermal expansion of the lens cap 3 is larger than the position shift of the semiconductor laser 1. Consequently, as a result the position of the lens 2 relative to the semiconductor laser 1 fluctuates. Consequently, the relative distance between the semiconductor laser 1 and the lens 2 becomes longer. That is to say, the exit point (object point) and the principal point of the lens 2 change. Accompanying this, the distance between the principal point and the focal point (imaging point) changes, and the focal point shifts in position by Δy in the direction of the optical axis A2 of the lens 2. In addition, the stem 6 elastically deforms with temperature increases and the relative position of the semiconductor laser 1 relative to the lens 2 changes in a direction orthogonal to the direction of the optical axis A2. Accordingly, the position of the focal point of the laser light shifts in position not only in the direction of the optical axis A2 but also by Δx in the direction orthogonal to the direction of the optical axis A2. The transparent member 7 is disposed so as to minimize this Δx and Δy.

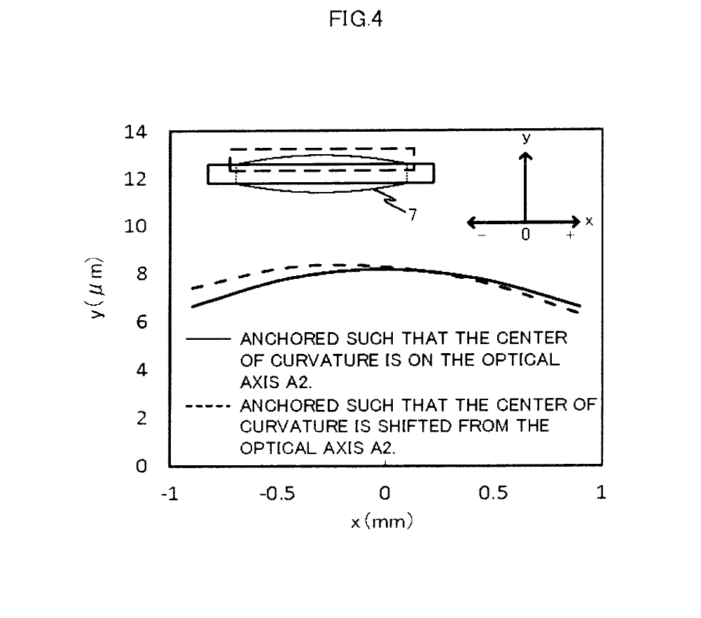

FIG. 4 shows the change in the shape of the surface on the focal point side assumed when the temperature changes from room temperature to 50° C., due to the status of the transparent member 7 being disposed so that the optical axis A7 of the transparent member 7 matches the optical axis A2 of the lens 2, and the status of the transparent member 7 being disposed so that the optical axis A7 of the transparent member 7 shifts from the optical axis A2 of the lens 2. As shown in FIG. 4, the direction of the optical axis A2 is taken as the y-axis and the direction orthogonal to the direction of the optical axis is taken as the x-axis. When the transparent member 7 is disposed so that the optical axis A7 of the transparent member 7 and the optical axis A2 of the lens 2 match, that is to say so that the center of curvature of the surface on the focal point side is on the optical axis A2 of the lens 2, a symmetric force centered on the optical axis A2 of the lens 2 is applied to the transparent member 7. Consequently, the change in shape of the surface on the focal point side as seen from the x-axis direction is symmetric in the x-axis direction relative to the position x=0 corresponding to the optical axis A2, as indicated by the solid line. In this case, the center of curvature of the curved surface after the shape change is maintained on the optical axis A2.

On the other hand, when the transparent member 7 is disposed so that the optical axis A7 of the transparent member 7 shifts from the optical axis A2 of the lens 2, that is to say so that the center of curvature of the curved surface on the focal point side is shifted from the optical axis A2 of the lens 2, an asymmetric force centered on the optical axis A2 of the lens 2 is applied to the transparent member 7. Consequently, the shape of the curved surface as seen from the x-axis direction is asymmetric in the x-axis direction with respect to the position x=0 on the optical axis A2, as indicated by the dashed line. Consequently, the center of curvature of the curved surface after the shape change is shifted from the position prior to the shape change. That is to say, the position of the optical axis A7 of the transparent member 7 relative to the optical axis A2 of the lens 2 moves due to deformation of the transparent member 7 caused by the asymmetric force centered on the optical axis A2 of the lens 2.

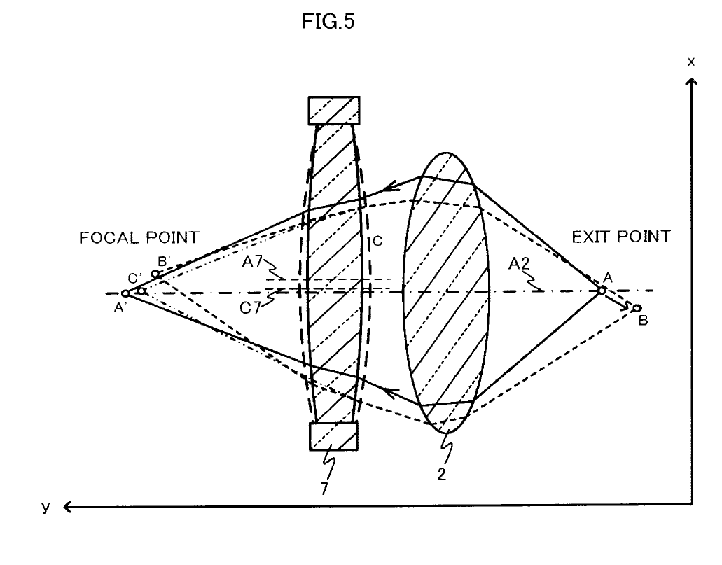

In consideration of this point, in order to control position shifting of the focal point accompanying position shifting of the exit point relative to the lens 2 caused by temperature changes, the transparent member 7 is anchored to the lens cap 3 shifted in a direction opposite the direction of the position shift of the exit point whose starting point is the optical axis A2 of the lens 2. FIG. 5 shows the lens 2 and the transparent member 7 in a cross-sectional view including a point A that is the exit point of laser light in a state in which the lens cap 3 has not yet thermally expanded and a point B that is the exit point with position shifted. Were this proper, the position of the lens 2 relative to the exit point would move due to thermal expansion, but for convenience, the explanation will assume that the exit point moves from the point A to the position of point B relative to the lens 2 as a reference. In this plane, the direction of the optical axis A2 is the y-axis and the direction orthogonal to the direction of the optical axis A2 is the x-axis, the same as in FIG. 4.

Laser light emitted from point A, which is the exit point in a state in which the lens cap 3 is not thermally expanded at room temperature, follows the optical path indicated by the solid lines and converges at a point A′, which is the focal point for the lens 2. Suppose that the exit point relative to the lens 2 has shifted from point A to point B due to rising temperature. In this case, supposing that the transparent member 7 does not deform, the laser light follows the optical path indicated by the dashed lines and converges at a point B′. In contrast, an explanation will be given for controlling position shifting of the point B′ in the x-axis direction. As shown in FIG. 5, the transparent member 7 is anchored to the lens cap 3 with the optical axis A7 of the transparent member 7 shifted in the positive direction opposing the negative direction of the x-axis, which is the direction of the position shift of the exit point originating at the optical axis A2 of the lens 2. Consequently, due to a deformation C caused by the asymmetric force centered on the optical axis A2 of the lens 2, the optical axis A7 of the transparent member 7 moves in the negative direction of the x-axis, which is the direction of the position shift of the point B originating at the optical axis A2 of the lens 2, and moves to a position indicated by C7.

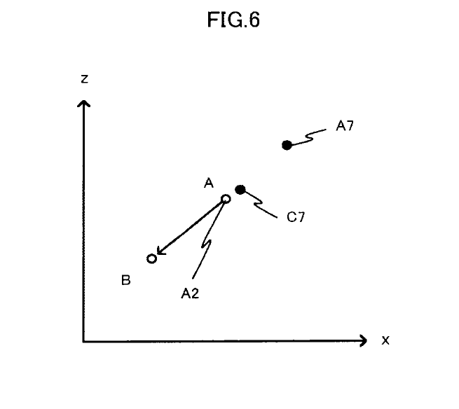

FIG. 6 is a drawing showing the positional relationship between the optical axis A7 of the transparent member 7 and the position shift of the exit point when viewed from the y-axis direction. The direction orthogonal to the x-axis direction and the y-axis direction is the z-axis. Suppose that the exit point has shifted to point B, which is in the negative direction of the x-axis and the negative direction of the z-axis, from point A on the optical axis A2. In this case, the transparent member 7 is anchored so that the optical axis A7 shifts in the positive direction of the x-axis and the positive direction of the z-axis in order to cancel the shift from point A to point B. Due to deformation caused by the asymmetric force centered on the optical axis A2 of the lens 2, the optical axis A7 moves to the position indicated by C7 in the negative direction of the x-axis and the negative direction of the z-axis. As a result, the focal point B′ shifts in the negative direction of the x-axis and the position shift in the x-axis direction from the focal point A′ to the focal point B′ is cancelled.

Next, an explanation will be given for controlling position shifting of the point B′ in the y-axis direction. Due to thermal expansion, the surface of the transparent member 7 on the semiconductor laser 1 side also changes shape in the direction of the semiconductor laser 1, the same as the change in shape of the surface of the transparent member 7 on the focal point side shown in FIG. 4. Consequently, as shown in FIG. 5, the thickness of the transparent member 7 in the y-axis direction becomes thicker due to temperature increases in the optical module 100. When the thickness of the transparent member 7 in the y-axis direction becomes thicker, the air-converted length of the optical path from the lens 2 to the focal point becomes that much shorter because the refractivity of the transparent material 7 is larger than the refractivity of the atmosphere. As a result, the focal point B′ shifts in the positive direction of the y-axis and the position shift in the y-axis direction from the focal point A′ to the focal point B′ is cancelled.

In addition, with the optical module 100, the position shift of the focal point in the y-axis direction, which is the direction of the optical axis A2 of the lens 2, is controlled by the optical magnification of the transparent member 7 becoming larger due to the change in refractivity accompanying the temperature change. The transparent member 7 is made of plastic, so the optical magnification of the transparent member 7 is such that refractivity declines accompanying increases in temperature. The transparent member 7 has a biconvex shape, so the optical magnification becomes larger. As a result, the focal point B′ shifts in the positive direction of the y-axis and the position shift in the y-axis direction from the focal point A′ to the focal point B′ is cancelled.

Ultimately, by disposing the transparent member 7, laser light emitted from point B follows the optical path indicated by the double-broken line and converges on point C′, as shown in FIG. 5. In this way, it is possible for the position shift of the focal point to be offset from point B′ to point C′.

As explained in detail above, with the optical module 100 according to this embodiment, an asymmetric force centered on the optical axis A2 of the lens 2 is applied to the transparent member 7 in accordance with thermal expansion. By the transparent member 7 deforming due to the asymmetric force centered on the optical axis A2 of the lens 2, the position of the optical axis A7 of the transparent member 7 relative to the optical axis A2 of the lens 2 moves in a direction approaching the optical axis A2. As a result, position shifting of the focal point accompanying position shifting of the semiconductor laser 1 relative to the lens 2 caused by changes in temperature is controlled. Consequently, it is possible to more easily and flexibly control position shifting of the focal point. In addition, by controlling position shifting of the focal point, it is possible to mitigate tracking errors caused by position shifting of the focal point.

With the optical module 100 according to this embodiment, a lens for creating collimated light need not be added in order to control position shifting of the focal point of the laser light, so it is possible to curtail increases in costs.

In addition, with the optical module 100, it is possible to optimize the transparent member 7 in order to control position shifting of the focal point, by adjusting the size of the shift between the optical axis A7 of the transparent member 7 and the optical axis A2 of the lens 2 so that the position shifting of the focal point becomes smaller.

In addition, the transparent member 7 is made of plastic. The plastic has a larger linear thermal expansion coefficient than the lens cap 3, so thermal expansion of the transparent member 7 is larger than that of the lens cap 3 in response to temperature changes. The transparent member 7 anchored to the lens cap 3 is anchored to a lens cap 3 having smaller thermal expansion than the transparent member 7, so the asymmetric force centered on the optical axis A2 of the lens 2 is readily applied to the transparent member 7. In addition, the plastic has a larger thermal optical coefficient than the lens 2, so changes in refractivity with temperature changes are larger than the lens 2. Consequently, the transparent member 7 is effective at cancelling position shifting of the focal point in the y-axis direction.

When the rim 7a of the transparent member 7 and the lens cap 3 are anchored by an adhesive, it is preferable for the adhesive to be uniformly distributed on the rim 7a so that the asymmetric force centered on the optical axis A2 of the lens 2 is ideally applied to the transparent member 7.

With this embodiment, the transparent member 7 was anchored with the optical axis A7 of the transparent member 7 shifted from the optical axis A2 of the lens 2, but this is intended to be illustrative and not limiting. For example, by coating adhesive asymmetrically centered on the optical axis A2 of the lens 2 so that position shifting of the focal point is controlled, even if the optical axis A7 of the transparent member 7 is not shifted from the optical axis A2 of the lens 2, because of the asymmetry of the adhesive part between the rim 7a of the transparent member 7 and the lens cap 3, the lens cap 3 thermally expands equally centered on the optical axis A2 of the lens 2 and an asymmetric force centered on the optical axis A2 of the lens 2 is applied to the transparent member 7. By the transparent member 7 deforming due to the asymmetric force centered on the optical axis A2 of the lens 2, the position of the optical axis A7 of the transparent member 7 relative to the optical axis A2 of the lens 2 moves in a direction approaching the optical axis A2, and position shifting of the focal point is controlled.

In addition, the surface of the transparent member 7 on the semiconductor laser 1 side and the surface on the focal point side respectively have curved surfaces with the same curvature. Because of this, regardless of which surface of the transparent member 7 is mounted in the transparent member as the surface on the semiconductor laser 1 side, there is no effect on optical properties, improving mass producibility. Naturally, it would also be fine for the surface of the transparent member 7 on the semiconductor laser side 1 and the surface on the focal point side to have curved surfaces with different curvatures, and for the curvatures to be adjusted so that position shifting of the focal point is controlled. In terms of optical properties, when a high transmittance is required, it would be fine for the surface of the transparent member 7 on the semiconductor laser 1 side and the surface on the focal point side to be coated with an antireflective (AR) coating.

The transparent member 7 is made of plastic, so the linear thermal expansion coefficient of the transparent member 7 is larger than the linear thermal expansion coefficient of the lens cap 3, which is made of metal. Because the linear thermal expansion coefficient is larger than that of the lens cap 3, the transparent member 7 has a larger degree of thermal expansion than the lens cap 3 in response to rising temperatures. Because the transparent member 7 is anchored via the rim 7a to the lens cap 3, free thermal expansion of the transparent member 7 is limited, and the force applied to the transparent member 7 becomes larger.

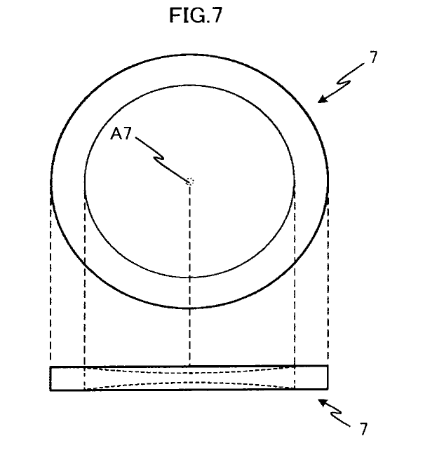

With the above-described embodiment, the transparent member 7 was made of plastic but this is intended to be illustrative and not limiting. For example, when the transparent member 7 is made of a material whose refractivity increases due to thermal optical effects when the temperature rises, it would be fine for at least one out of the surface of the transparent member 7 on the semiconductor laser 1 side and the surface on the focal point side to be formed in a concave shape. Specifically, the transparent member 7 is formed in a biconcave shape for example, as shown in FIG. 7.

### Second Embodiment

Next, a second embodiment of the present disclosure is explained. An optical module 200 according to this embodiment is the same as the optical module 100 according to the above-described first embodiment, but instead of the transparent member 7, a transparent member 8 whose shape differs from that of the transparent member 7 is provided.

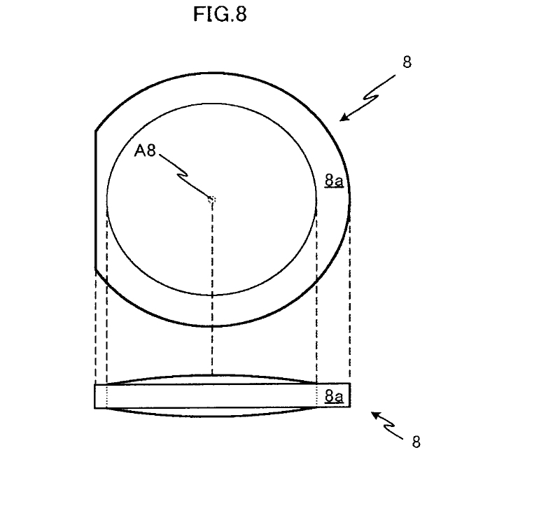

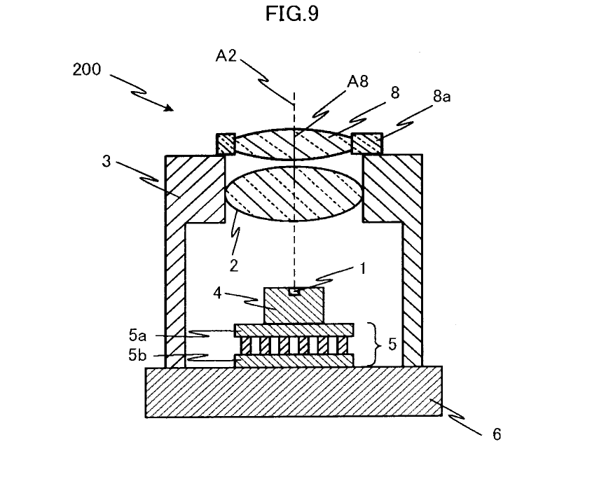

The shape of the transparent member 8 has rotational asymmetry about the optical axis A2 of the lens 2. Specifically, the shape of the transparent member 8 is a circular shape when viewed from the direction of the optical axis A2 of the lens 2 with a portion of the rim 8a cut away, as shown in FIG. 8. The transparent member 8 is anchored to the lens cap 3 so that the optical axis A8 of the transparent member 8 matches the optical axis A2 of the lens 2, as shown in FIG. 9. Because the transparent member 8 has rotational asymmetry about the optical axis A2 of the lens 2, the bonding surface between the lens cap 3 and the rim 8a of the transparent member 8 also has rotational asymmetry about the optical axis A2 of the lens 2. Because the lens cap 3 in contrast thermally expands equally in each direction about the optical axis A2 of the lens 2, an asymmetric force centered on the optical axis A2 of the lens 2 is applied to the transparent member 8 due to thermal expansion.

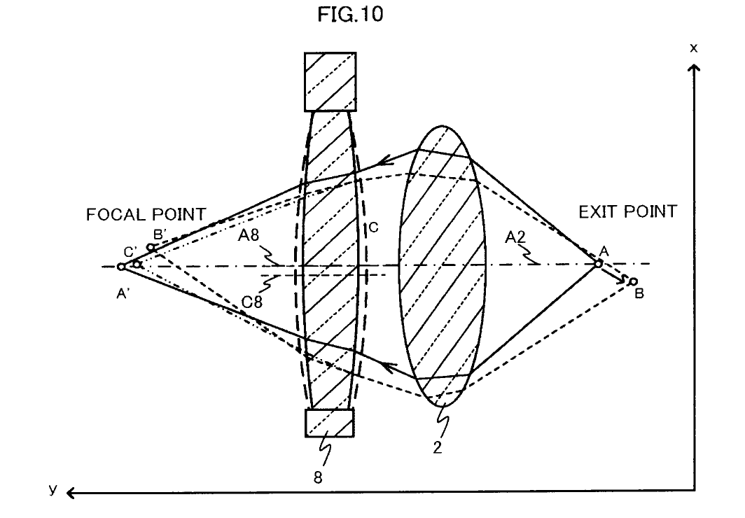

Similar to FIG. 5, FIG. 10 shows the lens 2 and the transparent member 8 in a cross-sectional plan including point A, which is the exit point of laser light when the lens cap 3 has not yet thermally expanded, and point B, which is the exit point with shifted position. Below, the explanation is primarily for points of difference from the above-described first embodiment. The transparent member 8 is anchored to the lens cap 3 so that the rim 8a is positioned with the bonding surface with the lens cap 3 becoming smaller in the negative direction of the x-axis, which is the direction of position shifting of the exit point, with the optical axis A8 of the transparent member 8 made to match the optical axis A2 of the lens 2. Due to deformation caused by the asymmetric force centered on the optical axis A2 of the lens 2, the optical axis A8 of the transparent member 8 moves in the negative direction of the x-axis, which is the direction of position shifting of point B starting from the optical axis A2 of the lens 2. The optical axis A8 of the transparent member 8 after deformation moves to a position indicated by C8.

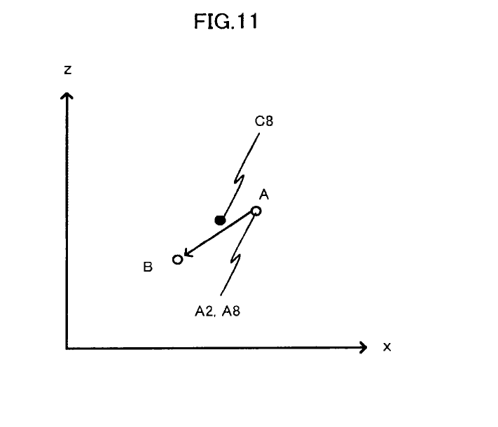

FIG. 11 is a drawing showing the positional relationship between the position shift of the exit point when viewed from the y-axis direction and the optical axis A8 of the transparent member 8. The exit point shifts from point A on the optical axis A2 to point B in the negative direction of the x-axis and the negative direction of the z-axis. In contrast, the transparent member 8 is disposed with the cutaway part of the rim 8a in the direction of point B, so due to deformation from the asymmetric force centered on the optical axis A2 of the lens 2 caused by thermal expansion, the optical axis A8 moves to the position indicated by C8 in the negative direction of the x-axis and the negative direction of the z-axis. As a result, the focal point B′ shifts in the negative direction of the x-axis, and position shifting in the x-axis direction from the focal point A′ to the focal point B′ is cancelled.

Similar to the above-described first embodiment, the thickness of the transparent member 8 increases due to thermal expansion while the optical magnification of the transparent member 8 increases accompanying rising temperatures, so the focal point B′ shifts in the positive direction of the y-axis, and position shifting in the y-axis direction from the focal point A′ to the focal point B′ is cancelled.

As shown in FIG. 10, by the transparent member 8 being disposed, laser light emitted from point B follows the optical path indicated by the double-broken line and converges at point C′. In this manner, it is possible to offset position shifting of the focal point from point 13′ to point C′.

With the transparent member 8, control of position shifting in a direction orthogonal to the optical axis A2 of the lens 2 is dependent on the shape of the transparent member 8, so it would be fine to adjust the shape of the transparent member 8 in conjunction with the size of the position shift of the focal point and the direction of the position shift, making it possible to respond flexibly to position shifting of the focal point.

### Third Embodiment

Next, a third embodiment of the present disclosure is explained. An optical module 300 according to this embodiment is the same as the optical module 100 according to the above-described first embodiment but is provided with a transparent member 9 instead of the transparent member 7.

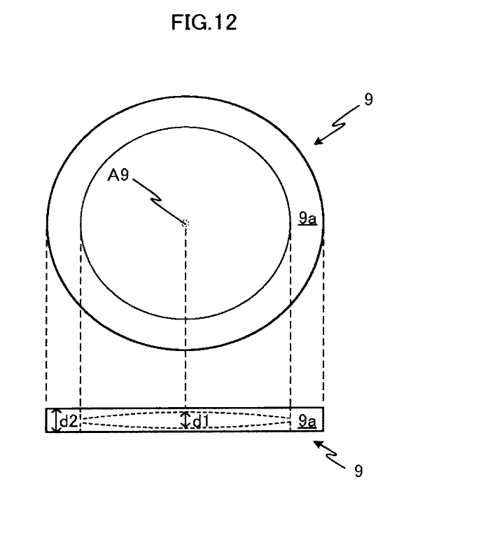

The transparent member 9 is such that the thickness from the surface on the semiconductor laser 1 side to the surface on the focal point side is thinner than the thickness of the rim 9a in the direction of the optical axis A2 of the lens 2. For example, as shown in FIG. 12 the shape of the transparent member 9 is such that the thickness d1 between the curved surfaces on the optical axis A2 of the lens 2 is thinner than the thickness d2 of the rim 9a in the direction of the optical axis A9. Through this, even if position shifting occurs when the transparent member 9 is anchored to the lens cap 3, it is possible to mount the transparent member 9 such that the part surrounding the optical axis A9 where most of the laser light emitted from the semiconductor laser 1 passes is not made to contact other members.

As explained in detail above, with the optical module 300 according to this embodiment, it is possible to mount the transparent member 9 without the part surrounding the optical axis A9 where most of the laser light emitted from the semiconductor laser 1 passes being made to contact other members. Consequently, it is possible to prevent deterioration of optical properties due to mistakes in mounting.

### Fourth Embodiment

Next, a fourth embodiment of the present disclosure is explained. An optical module 400 according to this embodiment differs from the optical module 100 according to the above-described first embodiment in the mounting state of the transparent member 7. The optical module 400 is provided with a lens cap 10 instead of the lens cap 3.

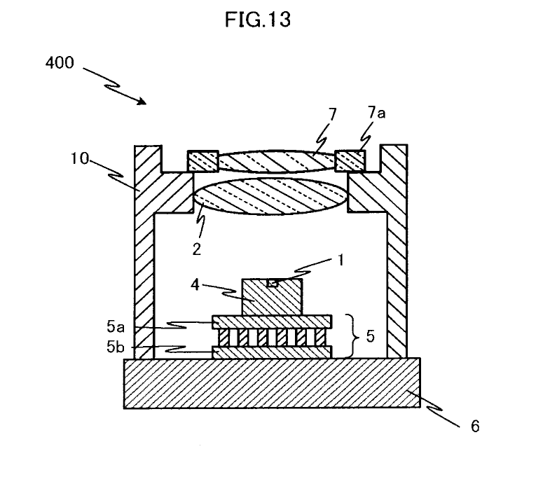

As shown in FIG. 13 the lens cap 10 has a notch in the surface on the focal point side. Consequently, the transparent member 7 is entirely within the lens cap 10. By doing this, it is possible to mount the transparent member 7 in the optical module 400 without exposing the transparent member 7 to the outside of the lens cap 10.

As explained in detail above, with the optical module 400 according to this embodiment, the transparent member 7 is not exposed to the outside of the lens cap 10, so it is possible to prevent damage to the surface of the transparent member 7 on the focal point side when handling the optical module 400.

With this embodiment, a lens cap 10 having a notch on the surface on the focal point side was used, but it would be fine to anchor the rim 7a of the transparent member 7 to the inner circumference of the lens cap 10 so that the entirety of the transparent member is within the lens cap 10.

### Fifth Embodiment

Next, a fifth embodiment of the present disclosure is explained. An optical module 500 according to this embodiment differs from the optical module 100 according to the above-described first embodiment in the mounting state of the transparent member 7.

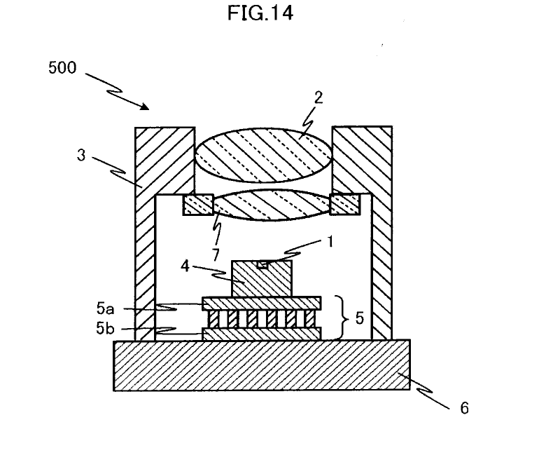

As shown in FIG. 14, the transparent member 7 is disposed between the lens 2 and the semiconductor laser 1 positioned inside the lens cap 3. The area inside the lens cap 3 is sealed airtight with nitrogen and/or the like, and thus does not receive the influence of temperature changes. Consequently, it is possible to prevent the permeability of the laser light in the transparent member 7 from declining due to temperature changes. In addition, it is possible to control to the utmost declines in the retaining force of the adhesive anchoring the transparent member 7 to the lens cap 3.

### Sixth Embodiment

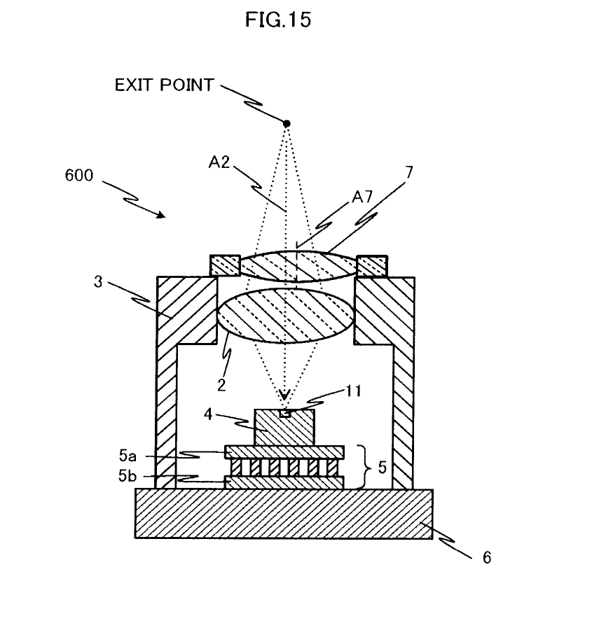

Next, a sixth embodiment of the present disclosure is explained. In this embodiment, an optical module 600 is explained taking as an example a TO-CAN type for receiving light. FIG. 15 shows the composition of the optical module 600 according to this embodiment. The optical module 600 has the same composition as that of the first embodiment with the exception that a photodiode 11 is provided instead of the semiconductor laser 1. Below, points of difference from the first embodiment are primarily explained.

In the position corresponding to the exit point, the output end of an optical fiber, for example, is disposed. Laser light emitted from the output end (exit point) of the optical fiber is focused by the lens 2 and is guided to the photodiode 11.

The photodiode 11 is disposed at a position corresponding to the focal point, and receives laser light emitted from the exit point. The photodiode 11 is such that the temperature is controlled by the Peltier device 5. By doing this, the influence of fluctuations in environmental temperature on the properties of the photodiode 11 is mitigated.

Temperature changes in the optical module 600 and position shifting of the focal point in this embodiment will be explained. When the lens cap 3 thermally expands due to temperature changes and the stem 6 undergoes elastic deformation, the position of the photodiode 11 relative to the lens 2 fluctuates. As a result, position shifting of the focal point occurs.

As described above with reference to FIG. 4, in response to temperature changes, asymmetric deformation occurs centered on the optical axis A2 of the lens 2. The transparent member 7 deforms under the asymmetric force centered on the optical axis A2 of the lens 2, and through this the position of the optical axis A7 of the transparent member 7 relative to the optical axis A2 of the lens 2 moves. As a result, position shifting of the focal point accompanying position shifting of the photodiode 11 relative to the lens 2 caused by temperature changes is controlled. Consequently, it is possible to control position shifting of the focal point easily and flexibly.

As explained in detail above, with the optical module 600 according to this embodiment, even when the optical module 600 receives laser light it is possible to control position shifting of the focal point, the same as in the first embodiment.

With the above-described embodiments, there was one lens 2 but this is intended to be illustrative and not limiting. It would be fine for multiple lenses to combine to focus the laser light as the lens 2. In addition, the lens cap 3 is not limited to being cylindrical, and may be a square tube. In addition, it would be fine for there to be a bottom on one end of the lens cap 3 anchored to the stem 6.

In the above-described explanation, a non-uniform force that causes the optical axes A7 and A8 of the transparent members 7 and 8 to move is applied to the transparent members 7 and 8 from the lens cap 3 primarily by anchoring the transparent member 7 to the lens cap 3 with the optical axis A7 of the transparent member 7 shifted from the optical axis A2 of the lens 2, or by anchoring the transparent member 8 to the lens cap 3 as a shape with rotational asymmetry. By doing this, it was possible to compensate for (cancel, offset) all or a portion of the shift in the focal position in the x-z plane.

The method itself of applying force to the transparent members 7 and 8 through thermal expansion and causing the optical axes A7 and A8 thereof to move is arbitrary. For example, it would be fine to find, for example through experimentation, the extent and direction in which the focal point moves due to temperature changes when in operation and when not in operation with the transparent member 7 not moving, and to find a shape, size, material and arrangement for the transparent member through experimentation so that the optical axis of the transparent member 7 moves or so that a non-uniform force is applied to the transparent member 7 by thermal expansion of the lens cap 3 or other members, to compensate for all or a portion of the movement of the focal point.

Similarly, regarding shifting of the focal point in the optical axis direction, it would be fine to find, through experimentation, the extent and direction in which the focal point moves due to temperature changes when in operation and when not in operation with the transparent 7 not thermally expanded, and to find the material, size, shape and arrangement and/or the like of the transparent material 7 so as to compensate for all or a portion of the movement of the focal point.

Having described and illustrated the principles of this application by reference to one or more embodiments, it should be apparent that the embodiments may be modified in arrangement and detail without departing from the principles disclosed herein and that it is intended that the application be construed as including all such modifications and variations insofar as they come within the spirit and scope of the subject matter disclosed herein.
1 Semiconductor laser
2 Lens
3, 10 Lens cap
4 Carrier
5 Peltier device
5a Top layer

05b Bottom layer
6 Stem
7, 8, 9 Transparent member
11 Photodiode
100, 200, 300, 400, 500, 600 Optical module
A2, A7, A8, A9 Optical axis
7a, 8a, 9a Rim

What is claimed is:

1. An optical module comprising:
an optical device for focusing at a focal point light emitted from an exit point;
a support body for supporting the optical device; and
a transparent member disposed on an optical path and anchored to the support body so that an asymmetric force centered on the on optical axis of the optical device is applied in accordance with thermal expansion.

2. The optical module according to claim 1, wherein the transparent member is anchored to the support body so as to control position shifting of the focal point accompanying position shifting of the exit point relative to the optical device caused by temperature changes, through deformation caused by the asymmetric force centered on the optical axis of the optical device.

3. The optical module according to claim 1, wherein the transparent member is anchored to the support body so that the optical axis of the transparent member moves in the direction of the position shift of the exit point originating with the optical axis of the optical device, caused by temperature increases.

4. The optical module according to claim 1, wherein:
the shape of the transparent member has rotational symmetry about the optical axis of the transparent member; and
the transparent member is anchored to the support body so that the optical axis of the transparent member moves in the direction opposite the direction of the position shift of the exit point originating with the optical axis of the optical device.

5. The optical module according to claim 1, wherein:
the shape of the transparent member has rotational asymmetry about the optical axis of the transparent member; and
the transparent member is anchored to the support body so that the optical axis of the transparent member matches the optical axis of the optical device.

6. The optical module according to claim 1, wherein position shifts of the focal point in the direction of the optical axis of the optical device are controlled by the optical magnification of the transparent member becoming larger due to changes in refractivity accompanying temperature changes.

7. The optical module according to claim 1, wherein the surface of the transparent member on the exit point side and the surface on the focal point side are respectively curved surfaces with equal curvatures.

8. The optical module according to claim 1, wherein:
the transparent member is anchored to the support body via a rim; and
the thickness from the surface on the exit point side to the surface on the focal point side is thinner than the thickness of the rim in the direction of the optical axis of the optical device.

9. The optical module according to claim 1, wherein the entirety of the transparent member is enclosed within the support body.

10. The optical module according to claim 1, wherein:
the support body has a cylindrical shape along the direction of the optical axis of the optical device, and supports the optical device so that the exit point or the focal point is positioned inside.

11. The optical module according to claim 1, wherein the transparent member is made of plastic.

12. A light transmission method, include:
a process for applying to a transparent member disposed on an optical path an asymmetric force centered on the optical axis of an optical device for focusing emitted light at a focal point, in accordance with thermal expansion; and
a process for controlling position shifts of the focal point accompanying position shifts of the exit point relative to the optical device caused by temperature changes, through deformation of the transparent member caused by the asymmetric force.
